(19) United States
(12) Patent Application Publication
(10) Pub. No.: US 2026/0215611 A1
(43) Pub. Date: Jul. 30, 2026

(54) HYBRID BEVERAGE PREPARATION DEVICE WITH REMOVABLE BEVERAGE SUBSTRATE CONTAINER

(71) Applicant: EUGSTER / FRISMAG AG, Amriswil (CH)

(72) Inventors: Martin HOFFMANN, Steinach (CH); Alain ROTH, Kesswil (CH)

(21) Appl. No.: 19/142,111

(22) PCT Filed: Oct. 12, 2023
(86) PCT No.: PCT/EP2023/078386

§ 371 Date: Jun. 20, 2025

(30) Foreign Application Priority Data
Dec. 22, 2022 (DE) 10 2022 134 466.5

(51) Int. Cl. A47J 31/36

(52) U.S. Cl. CPC A47J 31/3619

(57) ABSTRACT

The invention relates to a beverage preparation device (01), comprising a beverage substrate container (03) which can be removed from a receiving area (02). The device has a brewing head (12) which can be adjusted in a vertical direction (V) and which is designed and arranged relative to the receiving area (02) and the beverage substrate container (03) received therein such that the beverage substrate container (03) can be inserted into and removed from the receiving area (02) in an upper position of the brewing head (12), closes and/or seals a brewing chamber formed by the brewing head (12) and the beverage substrate container (03) in a first lower position, and vertically presses against a beverage substrate (22) in the beverage substrate container (03) in a second lower position. The adjustable brewing head (12) is designed to interact with a mechanical adjusting unit (13), in particular an adjusting unit which can be manually operated, in order to be converted at least into the upper, first lower, and second lower position. According to the invention, the adjusting unit (13) allows a continuous locking of the brewing head (12) in the vertical direction (V) solely below a first lower position.

### CROSS-REFERENCE TO RELATED APPLICATIONS

This application is a US National Stage of PCT/EP2023/078386 filed on Oct. 12, 2023, which claims priority to DE 10 2022 134 466.5 filed on Dec. 22, 2022, both of which are incorporated by reference herein for all purposes.

### FIELD

The present invention relates to a beverage preparation device, in particular a coffee and/or espresso machine, according to the preamble of claim 1.

### BACKGROUND

Various beverage preparation devices, in particular coffee and/or espresso machines, are already known from the state of the art. A distinction is generally made between fundamentally different types of devices.

On the one hand, so-called fully automatic machines are known in which, starting with the grinding of a beverage substrate, for example coffee beans, through the filling of a brewing chamber and the brewing of the beverage substrate, in particular ground coffee beans, to the ejection or discharge of the leached or brewed substrate or pomace, all process steps for the production and dispensing of a corresponding beverage, in particular hot beverage, take place within a device or take place in a device which is bounded by a shared housing. For this purpose, the device can also have a water tank for storing fresh water, drip trays for storing residual water and pomace containers for collecting brewed or leached substrate cake or pomace. With such fully automatic machines, there is a greater risk that the presence of organic beverage substrate, in particular ground coffee beans, as well as the presence of water, hot water, steam, water condensate, dripping water or the like, can lead to hygienically problematic conditions inside the device, which can lead in particular to the formation of germs or mold if the organic substances, in particular the beverage substrate and/or pomace residues, are not removed regularly and conscientiously.

Furthermore, various embodiments of so-called sieve holder machines already exist in the state of the art. In these, a beverage substrate holder or sieve holder is designed to be removable from and/or insertable in a receptacle. This allows the beverage substrate, in particular the ground coffee beans, to be obtained from an external storage or production unit, for example an external grinder, and to be filled in the removed beverage substrate holder. The beverage substrate can then be pre-compacted in the beverage substrate holder, in particular to improve the quality of the beverage to be produced, in particular the beverage to be brewed, which can also take place externally to the beverage preparation device, for example manually in classic beverage preparation machines. After this pre-compaction, known as tamping, the prepared beverage substrate holder is inserted into the receptacle or connected to the receptacle, for example using a bayonet catch or similarly designed connecting means. To brew the beverage, a brewing fluid can then be dispensed via a brewing unit when the beverage substrate holder is inserted or attached, the brewing fluid entering a brewing chamber which is usually formed or defined by the brewing unit and the inserted or attached beverage substrate holder, in particular the sieve holder. The pressurized and/or supplied brewing fluid leaches the beverage substrate while flowing through it as evenly as possible or brews the beverage substrate and flows to an outlet of the beverage substrate holder, at which the prepared beverage thus emerges. The advantage of the sieve holder machines or device based on the concept of a sieve holder machine is that no or only a minimal amount of beverage substrate or pomace remains on or in the device, so that correspondingly little organic material is available, which can contribute to unhygienic conditions when exposed to moisture and heat. However, the device based on the principle of a sieve holder machine has the disadvantage that the external supply of the beverage substrate sometimes results in a discharge of beverage substrate and/or pomace in the vicinity of the beverage preparation device and/or an external mill, which also causes a corresponding need for cleaning.

Hybrid device concepts are also already known in the state of the art, which attempt to combine a removable beverage substrate holder or sieve holder with an integrated beverage substrate supply, for example a supply shaft, and/or with integrated mills for producing the beverage substrate, for example from coffee beans. Such devices are known, for example, from EP 2 811 876 A1. In this hybrid approach of a beverage preparation device, it is provided in various embodiments that not only the filling of a removable beverage substrate holder or sieve holder is achieved by a supply device integrated in the device, which may be designed to interact with a mill, but that a pre-compaction or tamping of the beverage substrate filled into the beverage substrate holder prior to brewing is also achieved via hydraulic or mechanical solutions by means of a brewing unit mounted so as to be displaceable in the vertical direction, which is also used as a contact surface with the beverage substrate.

The mechanical pre-compaction of the beverage substrate described in this approach also intends a mechanically actuated and controlled brewing process to be carried out subsequently. However, this does not lead to consistently good results in terms of the beverage produced or dispensed if the operator is not very experienced and/or trained. Furthermore, with the mechanical adjustment of the brewing unit described there, the pre-compaction also depends on the user's operation and is therefore only possible in a highly reproducible manner for appropriately skilled and experienced users. Since in particular the brewing process with its operating parameters and, within certain limits, the correct pre-compaction is also dependent on the quantity of beverage substrate used in order to enable an optimal and reproducible result of the beverage produced, the mechanical solution of EP 2 811 876 A1 only offers the possibility of effective use for very experienced operators, for example in the catering sector.

The hydraulic or electric drive options also described in EP 2 811 876 B1 for adjusting the brewing unit and/or for tamping the beverage substrate lead to an undesirably high level of complexity of the beverage preparation device and thus to components and component group which are prone to faults and may require maintenance and care as a result of the machines design.

WO 2022/033 908 A1 discloses a mechanical brewing group for use in an espresso or coffee machine. The brewing group operates with a sieve holder, and the vertical movement of the brewing piston from an open position to a pressure-tight, closed position is operated by means of a hand lever.

EP 0 978 245 A1 shows a coffee brewing device for use in a fully automatic coffee machine. The extensive electrical system includes a position switch for determining the position of a cam on a cam shaft for controlling a lever mechanism. This lever mechanism acts both on the tamping of coffee powder in a brewing chamber and on the pressure build-up in a water-filled cylinder for pressurized water delivery into the brewing chamber.

DE 20 2014 002 225 U1 shows a sieve holder coffee machine in which the existing elements for interlocking the sieve holder, i.e., lugs or protrusions located on the circumference, are used by means of suitable sensors/switches for presence detection and also for type detection. This serves to prevent piston movement or water release if no sieve holder is inserted and to select the brewing parameters according to the sieve holder used.

DE 10 2009 001 198 A1 shows a coffee machine for coffee pods, a bypass being provided by means of which any pressure still present in the brewing chamber is released after the coffee has been dispensed. This bypass is opened by means of a valve which can be controlled mechanically. The valve is coupled to the opening movement of the brewing chamber in such a manner that when it is opened manually, the bypass valve is opened first and then the brewing chamber.

### SUMMARY

The object of the invention at hand is therefore to overcome the problems described above on the basis of the state of the art, in particular to propose a hybrid beverage preparation device which enables an improved or optimal result of the beverage produced for a mechanical actuating unit for adjusting a movable brewing unit, in particular also for inexperienced or untrained users.

The object of the invention at hand is attained by a beverage preparation device having the features of claim 1. Advantageous embodiments of the invention are the subject of the following description, the description of the figures and the figures. In principle, all features and properties disclosed with respect to the device are also to be regarded as correspondingly disclosed and claimable with respect to the method, and vice versa.

The beverage preparation device according to the invention, in particular a coffee and/or espresso machine, having a beverage substrate holder, in particular a sieve holder, removable from a receptacle, accordingly provides a brewing unit which is adjustable in the vertical direction and which disposed and configured such with respect to the receptacle and the beverage substrate holder received therein that the beverage substrate holder is removable from and insertable in the receptacle in an upper position—such as a grinding position—of the brewing unit and a brewing space formed by the brewing unit and the beverage substrate holder is closed and/or sealed in a first lower position, a vertical contacting of the brewing unit against a beverage substrate in the beverage substrate holder taking place in a second lower position, which is preferably located at the same height as or below the first lower position, in particular provided that a minimum amount of beverage substrate is held in the beverage substrate holder, the brewing unit being connected to a brewing water supply in such a manner as to conduct fluid in order to discharge brewing fluid and/or to supply it to the brewing chamber, and the beverage preparation device moreover having a supply duct for providing beverage substrate, the supply duct being disposed and designed such on one end that the beverage substrate can be filled from the supply duct in the beverage substrate holder, which is inserted in the receptacle, preferably merely under the influence of weight and preferably on the other end forms a transition to a mill surrounded by the beverage preparation device, the displaceable brewing unit being configured to interact with a mechanical, preferably purely mechanical, in particular manually operable, actuating unit in order to displace the brewing unit at least into the upper, first lower and second lower position. According to the invention, it is provided that the actuating unit allows a continuous interlocking of the brewing unit in the vertical direction exclusively below a first lower position.

The continuous interlocking of the brewing unit via the mechanical actuating unit has various advantages. On the one hand, regardless of the quantity or volume of the beverage substrate used, a desired and possibly predetermined pre-compaction of the beverage substrate can be achieved in the second, lower position. This forms the basis for achieving a reproducible tamping regardless of the quantity or volume of the beverage substrate in order to provide the starting situation for a reproducible brewing process.

The continuous interlocking of the brewing unit via the actuating unit also has the advantage that these, unlike sealants, for example, are not subject to any wear or only imperceptible wear at the transition between the brewing unit and the beverage substrate holder, so that the continuous interlocking can be reliably generated even after a correspondingly high number of operating processes and can also be reliably maintained during the subsequent internal pressure within the brewing space or the brewing chamber during the brewing process.

Furthermore, the continuous interlocking of the brewing unit via the actuating unit enables the pre-compaction pressure or contact pressure of the tamp to be maintained continuously or without interruption after the brewing unit has been locked in place, especially until the brewing fluid flows in, and the brewing fluid to also be introduced using a correspondingly well-defined brewing profile which can be easily handled via control circuits following the interlocking of the brewing unit so that, in addition to the more reproducible tamping or pre-compaction of the beverage substrate, the subsequent brewing process can also be carried out with a very high degree of precision and reproducibility.

According to a first advantageous embodiment, it may be provided that the actuating unit has a rod moveable together with the brewing unit and a locking bush which is immobile in the vertical direction and surrounds the rod, the rod being designed such that a fixation in a first lower section of the rod via the locking bush is impossible and the rod being designed such in a second upper section that a discontinuation of a vertical downwards movement of the rod, in particular with respect to the locking bush, results in a locking force fit between the locking bush and the rod, the force fit causing or supporting the interlocking of the brewing unit, preferably over the entire second section, with respect to the locking bush.

The lower section and the upper section of the rod can advantageously be designed differently due to their external geometry, for example due to their cross sections or the like, so that the brewing unit cannot become interlocked in the lower section of the rod, for example due to a smaller cross section. This is particularly advantageous in order to enable the user to stop or interrupt the adjustment process in a first area or in a first section of the displacement of the brewing unit, for example from a grinding position to a tamping position or brewing position, without automatically interlocking the brewing unit. The upper section of the rod, on the other hand, which can be designed such with respect to the displacement path of the brewing unit and/or with respect to the arrangement relative to the locking bush or can extend in such a manner that interlocking the brewing unit is only made possible when it has reached the first lower position and the brewing chamber or the brewing space consisting of the beverage substrate holder and brewing unit is closed accordingly and sealed, makes it possible to achieve and maintain an interlocking in any continuous position or any position of the brewing unit relative to the beverage substrate holder and thus essentially independently of the quantity or volume of the beverage substrate filled in the beverage substrate holder; although purely mechanical in nature, the interlocking does not depend on the interaction of the brewing unit and the beverage substrate holder, but is achieved independently of these via the actuating unit, in particular via the interaction of the rod and the locking bush.

According to a further, particularly advantageous embodiment, it may be provided that a second locking mechanism, preferably a toggle lever mechanism, is configured such that the interlocking of the brewing unit is achieved and/or supported via the second locking mechanism in addition to the locking bush. It may be particularly preferred that the second locking mechanism, in particular the toggle lever mechanism, is also designed as part of the mechanical, preferably manually operable actuating unit. For example, it may be provided that the toggle lever mechanism, as an exemplary or preferred second locking mechanism, is also actuated by an operating or actuating lever which can be operated by the operator and is designed in such a manner that, after an interlocking of the brewing unit has been achieved via the interlocking of the locking bush on the movable rod, a dead center of the toggle lever mechanism is overcome, which then prevents an unintentional or undesired release of the locking bush. It is also particularly preferable that the second locking mechanism is released when releasing the interlocking of the brewing unit, if necessary also via a corresponding, in particular reversed operation of the operating or actuating lever, before the locking bush is released from the rod or the corresponding interlocking is released.

In a further, particularly advantageous embodiment of the beverage preparation device, it may be provided that a contact surface of the brewing unit, in particular a wetting or brewing sieve, is movable in the vertical direction against an elastic pre-tensioning device, preferably a spring element, with respect to the actuating unit and/or the remaining part of the brewing unit so that the further movement of the actuating unit and/or the remaining part of the brewing unit results in a reduced movement of the contact surface in the vertical direction and in a contact force on the beverage substrate upon a vertical displacement of the actuating unit and/or the brewing unit as soon as the beverage substrate disposed in the beverage substrate holder is contacted with the contact surface, the contact force being limited or reduced in particular by an elastic deformation of the pre-tensioning device. In this context, it is particularly preferable for the pre-tensioning device to be designed in such a manner that an essentially constant contact pressure of the contact surface is exerted on the beverage substrate independently or largely independently of the elastic deformation of the pre-tensioning device. This can be achieved particularly advantageously if a means, for example a spring or a spring package, is used as the pre-tensioning device, which has a constant spring constant or a spring constant independent of the deformation over a wide range of the deformation. This achieves in a particularly advantageous manner that the pre-compaction/tamping of the beverage substrate takes place with a constant force or a constant pressure regardless of the filling quantity or filling height of the beverage substrate holder, in particular the sieve holder, meaning the brewing process can be made more reproducible on this basis if it is ensured that a largely identical or identical pre-compaction of the beverage substrate has taken place in each brewing process.

A further advantage of the elastic pre-tensioning device can be that the actuating unit, in particular an operating or actuating lever operated directly by the operator, is moved to one and the same end position during each brewing process or during the preparation of each brewing process, essentially an elastic deformation of the pre-tensioning device taking place as soon as the brewing unit, in particular the contact surface of the brewing unit, is contacted with the beverage substrate until the actuating lever of the actuating unit has been moved into the end position, without this causing a noticeable or substantial further displacement of the brewing unit in the vertical direction.

Alternatively, the advantageous, unambiguous end position essentially independent of the filling level of the beverage substrate holder or end position of an operating or actuating lever actuated directly by the operator can also be achieved by an interruption or decoupling within the force transmission of the actuating unit. The two end positions are also preferably determined by the geometry of mechanical stops provided for this purpose. These can be incorporated in the respective mechanical component, for example in a toggle lever mechanism or a movement mechanism.

In a further, particularly advantageous embodiment of the beverage preparation device, a sensor device is provided for detecting the position, in particular for detecting the vertical position, of the brewing unit and/or the contact surface in an interlocked position of the brewing unit, the sensor device being designed so as to operatively connect with a control unit of the beverage preparation device so that operating parameters of the beverage preparation device, in particular parameters of a fluid pump serving for conveying brewing fluid and surrounded by the device, are indicatable and/or adjustable via the control unit depending on the detected position. The sensor device can, for example, be designed as an optical sensor in the visible spectral range, preferably as a light barrier. In addition to a direct measurement of the brewing unit and/or the contact surface of the brewing unit in the interlocked position, an indirect measurement can also take place, for example via parts of the actuating unit, such as the position of a rod which can be moved vertically together with the brewing unit, in order to draw conclusions about the position of the brewing unit and/or the contact surface. In this case, it can be particularly advantageous if the sensor device is also configured to detect the deformation state of the pre-tensioning device, provided an elastically deformable pre-tensioning device is realized, since the end position of the brewing unit and/or the contact surface is then dependent both on the position of the actuating unit and on the position or state of the pre-tensioning device. In particular, if the actuating unit is always brought into one and the same end position when vertically displacing the brewing unit, it may also be advantageous for the sensor device to only detect the deformation state of an elastic pre-tensioning device and, based thereon, to infer the position of the brewing unit and/or the contact surface.

The operating parameters of the beverage preparation device which are controlled and influenced by the control unit can basically be arbitrary. For example, the control of the operating parameters can go so far as to completely prevent operation of the beverage preparation device if the sensor device detects that the brewing chamber or the brewing space is not yet closed. Operation or the execution of a brewing process can also be prevented by the control device if the position of the brewing unit and/or the contact surface indicates that a minimum amount of beverage substrate is not present in the beverage substrate holder. In the case of such a position detection, it may alternatively also be intended that the control unit only enables a cleaning and/or rinsing process to be carried out. If, on the other hand, a position of the brewing unit is detected by the sensor device, which detects a filling of the beverage substrate holder between a minimum filling and a maximum filling, the operating parameters of a subsequent brewing process can be influenced by the operative connection and the resulting control circuit with the control unit, depending on the detected state or the detected position of the brewing unit.

For example, the grinding time of the mill can be regulated to the beverage substrate output of the mill resulting from a bean selection and from a set grinding degree of the mill so that the filling of the beverage substrate holder is within the intended minimum and/or maximum volume and the beverage substrate quantity can be adjusted between these limits in steps or continuously depending on the desired beverage strength.

Furthermore, for example, the conveying rates of a fluid pump, the steepness and length of corresponding ramps in the control of a fluid pump and the correspondingly parameterized control of heating devices, in particular thermoblocks for the temperature control of brewing fluid, can be influenced accordingly.

According to a further, particularly advantageous embodiment of the beverage preparation device, it can be intended that the brewing unit is configured such that a mechanical lock of the beverage substrate holder is achieved on and/or in the receptacle upon a vertical displacement of the brewing unit starting with a third lower position. This can ensure that unintentional movement or unintentional removal of the beverage substrate holder is avoided. The designation as a third lower position is not intended to imply an inevitable arrangement or alignment in the vertical direction, in particular with respect to the second lower and/or first lower position. For example, it may advantageously be intended that the third lower position is disposed in the vertical direction still above the first lower position, meaning a mechanical locking of the beverage substrate holder on or in the receptacle takes place before the brewing space or the brewing chamber is closed. Alternatively, it may also be intended that the locking occurs simultaneously with the closure of the brewing space or the brewing chamber. Further alternatively, it may also be intended that an interlocking does not take place until after the brewing unit has been closed and/or sealed on or in the beverage substrate holder, which then means that the third lower position is disposed below the first lower position.

According to a further, likewise advantageous embodiment, a contact, preferably as part of a microswitch, may be provided, by means of which the position and/or presence of the beverage substrate holder is detected or revisable in the receptacle. Particularly preferably, it may be provided that the contact, similar to the sensor device already described above, is operatively connected to a control device in such a manner that certain functions of the beverage preparation device, in particular the execution of a brewing process and/or the lowering of the brewing unit via the actuating unit, can only be carried out or can only be successfully initiated by the operator if said contact detects the presence and/or correct positioning of the beverage substrate holder on or in the receptacle. The contact can preferably be formed on the receptacle, in particular projecting over a surface of the receptacle, on which the beverage substrate holder comes to rest.

In a further, particularly preferred embodiment of the beverage preparation device, it may further be provided that the brewing unit has an upper part and a lower part which are moveably mounted against each other in the vertical direction, a mechanically actuatable valve being designed such in the brewing unit that a relative movement of the upper part and the lower part away from each other opens the valve and allows a ventilation of the brewing unit in particular even below the first lower position of the brewing unit. This can be particularly advantageous for ventilating the brewing chamber or the brewing space after a brewing process has been carried out. Otherwise, there is a risk that a vacuum builds up in the brewing chamber or brewing space after the brewing process when the brewing unit is lifted in relation to the beverage substrate holder, in particular the sieve holder, the vacuum then being abruptly released when the brewing unit passes the first lower position in the vertical upward direction. This can lead to unwanted spraying out of pomace or brewed beverage substrate and/or liquid. The two-part design of the brewing unit and the corresponding realization of a mechanically actuatable valve can ensure that after the brewing process, when the actuating unit is initially adjusted vertically with the aim of adjusting the brewing unit vertically upwards, the two parts, in particular the upper part and the lower part of the brewing unit, first move away from each other, whereby the mechanically operable valve is then first opened and a fluid connection is established between the environment and the interior of the brewing space or the brewing chamber, which ensures that no negative pressure is built up in the brewing chamber or in the brewing space during the further movement or displacement of the actuating unit and thus of the brewing unit.

Conversely, when sealing and/or compacting the beverage substrate prior to a brewing process, the two-part design of the brewing unit with an upper part and a lower part and the mounting of the upper part and the lower part, which can move in a vertical direction relative to one another, in conjunction with a corresponding mechanically actuatable valve, can also ensure that no air cushion forms above the beverage substrate and below the brewing unit during pre-compression of the beverage substrate. This is because as long as the upper part of the brewing unit and the lower part of the brewing unit are in a state with a greater vertical relative distance to each other, for example realized by a corresponding pre-tension, the mechanically actuatable valve can be held in an open state, which then also enables venting of the brewing space or the brewing chamber. The mechanically actuatablee valve is then only closed when, for example, a force is exerted on the brewing unit by the beverage substrate or the beverage substrate holder, which results in the upper part and the lower part of the brewing unit coming closer together and thus closing the valve. The closed valve position is again advantageous in order to enable and maintain the tightest possible design of the brewing space or brewing chamber during the brewing process.

According to a further, particularly advantageous embodiment of the beverage preparation device, it can be intended that the upper part and the lower part of the brewing unit are connected to each other with a radially circumferential profile seal which causes a radial expansion or swelling of the profile seal upon a relative movement of the upper part and the lower part towards each other in a vertical direction, thus achieving a contacting of the profile seal against an inner wall of the beverage substrate holder below the first lower position. This design, particularly together with the design of the brewing unit having an upper part and a lower part which are mounted so that they can move vertically in relation to each other, not only ensures the advantageous aeration and ventilation of the brewing space or the brewing chamber, as already described above. In addition, an improved sealing effect of the brewing unit on the beverage substrate holder and/or reduced wear of the corresponding seal can also be achieved, since the sealing effect is only produced or improved by the fact that a radial swelling of the profile seal and thus a contacting against the interior wall of the beverage substrate holder is achieved with the relative movement of the upper part of the brewing unit towards the lower part.

The profile seal can also be provided particularly advantageously, as it can provide a corresponding restoring force which forces the upper part of the brewing unit away from the lower part of the brewing unit and can thus ensure that the mechanically actuatable valve remains in a normally open position as long as the distance between the upper part of the brewing unit and the lower part of the brewing unit does not fall below a limit value or the upper part and lower part do not approach each other to a certain extent.

Advantageous embodiments and details of the beverage preparation device according to the invention are explained below with reference to the merely schematic illustrations of embodiment examples. Identical components of the device or parts with the same function are marked with the same reference numerals.

### BRIEF DESCRIPTION OF THE DRAWINGS

FIG. 1: shows a sectional view through parts of a beverage preparation device according to the invention in a grinding or filling position of the actuating unit.

FIG. 2: shows a sectional view through parts of a beverage preparation device according to the invention in an intermediate position of the actuating unit.

FIG. 3: shows a sectional view through parts of a beverage preparation device according to the invention in an end position or brewing position of the actuating unit.

FIG. 4: shows a sectional view illustrating the interlocking of the brewing unit using a sectionally continuously self-locking or self-interlocking locking bush.

FIG. 5a: shows a detailed illustration of the interlocking of the locking bush.

FIG. 5b: shows a detailed illustration of the interaction of the locking bush with the other actuating unit.

FIG. 6: shows a detailed illustration of a brewing unit having an upper part and a lower part.

### DETAILED DESCRIPTION

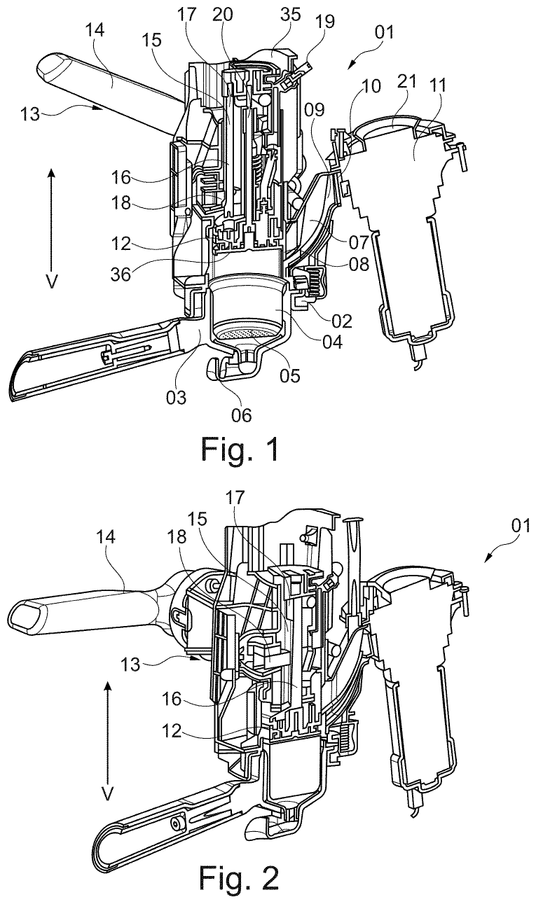

FIG. 1 shows a sectional view of a beverage preparation device 01, parts or components of the beverage preparation device 01 not being shown for reasons of clarity. Essentially, the sectional view of FIG. 1 shows a beverage substrate holder 03 inserted into a receptacle 02 and in the form of a sieve holder. The beverage substrate holder 03 comprises an interior wall 04, a bottom sieve 05, a discharge element 06 formed below the sieve 05 and serving for dispensing or delivering a brewed beverage.

A supply shaft 07 is formed above the receptacle 02 and serves to provide beverage substrate, in particular ground coffee beans. At one end 08, the supply shaft 07 is disposed and designed such that the beverage substrate can be filled from the supply shaft 07 into the beverage substrate holder 03 inserted into the receptacle 02, preferably only under the influence of the weight. At a second end 09, the supply shaft 07 forms a transition 10 to a mill 11 preferably surrounded by the beverage preparation device 01. The beverage preparation device 01 also comprises a brewing unit 12 which is movably guided in the vertical direction V within a housing part 35 and which forms a contact surface 36, preferably in the form of a sieve 05, at the lower end. The brewing unit 12 is connected to an actuating unit 13, which also comprises an operating or actuating lever 14. Based on the application of force and/or a corresponding movement of the operating or actuating lever 14, the brewing unit 12 is moved upwards or downwards in the vertical direction V by a corresponding movement or adjustment of the actuating unit 13. In the illustration of FIG. 1, the brewing unit 12 is shown in a first, upper position, in which the beverage substrate holder 03 can be removed from the receptacle 02 and inserted into the receptacle 02, for example to remove brewed and leached beverage substrate or pomace from the beverage substrate holder 03.

The illustration in FIG. 1 already shows that the actuating unit 13 driven by the operating or actuating lever 14 has a rod 15 having a lower section 16 and an upper section 17, the rod 15 being enclosed at least in sections by a locking bush 18. The rod 15 and the locking bush 18 will be discussed in more detail. However, it is already apparent that the lower section 16 of the rod 15 has a smaller cross section than the upper section 17 of the rod 15.

In the illustration of FIG. 1, a connection element 19 is also shown, which is preferably connected to a hose and can serve to dispense brewing fluid, in particular brewing water, for brewing beverage substrate via the brewing unit 12, in particular the contact surface 36. The conduit means between the connection element 19 and the contact surface 36 are not shown in detail in the sectional view of FIG. 1.

FIG. 1 shows a further guide rod 20 in addition to the rod 15, which is enclosed in sections by the locking bush 18 and is disposed eccentrically to the brewing unit 12. The centrally disposed guide rod 20 is not recognizable in the following sectional views. According to the invention, it is possible to provide the rod 15 in addition to the eccentric guide rod 20. However, it can also be intended that the functionality of the rods 15 and 20 is integrated in a common rod 15 and thus the number of rods 15 and 20 is reduced accordingly by one rod.

An inlet opening 21 is formed above the mill 11, the inlet opening 21 being able to, for example, form the transition to a storage container disposed above the mill 11, in particular a coffee bean storage container.

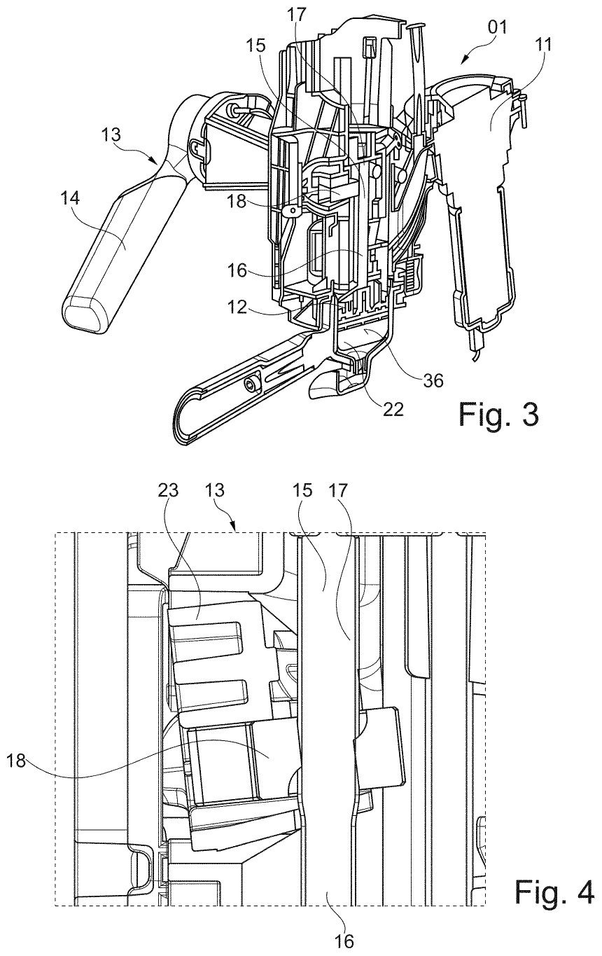

The illustrations in FIGS. 2 and 3 show how the actuating unit 13 is moved from the position shown in FIG. 1 to a position in which a brewing process of the beverage preparation device 01 is initiated, starting from the actuation of the operating or actuating lever 14 of the actuating unit 13.

FIG. 2 already shows that lowering or pressing down the operating or actuating lever 14 via a corresponding, purely mechanical transmission kinematics of the actuating unit 13 results in the brewing unit 12 being lowered relative to the beverage substrate holder 03 and the receptacle 02. In the intermediate position of FIG. 2, the brewing unit 12 is still slightly above the upper edge of the interior wall 04 of the beverage substrate holder 03. This means that the brewing space or the brewing chamber is not yet closed, which means that the first lower position of the brewing unit 12 in vertical direction V has not yet been reached. However, it can already be seen that a relative movement of the rod 15 with respect to the locking bush 18 has taken place due to the displacement of the brewing unit 12, the locking bush 18 being essentially immovably disposed in the vertical direction V in the beverage preparation device 01.

However, the part of the locking bush 18 which surrounds the rod 15 is still located in the lower section 16 of the rod 15. Due to the smaller cross section of the lower section 16 of the rod 15, the locking bush 18 in the position shown in FIG. 2 cannot yet cause any inhibition or interlocking of the rod 15 relative to the locking bush 18. This means that if the actuating process of the actuating unit 13 were to be interrupted in the position of FIG. 2 and the operating or actuating lever 14 were to be returned to the starting position of FIG. 1, there would be no locking of the rod 15 relative to the locking bush 18, which in other words means that a return would be possible without a locking effect of the locking bush 18 first having to be overcome or removed.

In the illustration in FIG. 3, the operating or actuating lever 14 has been moved to a lower end position. Preferably, this position is identical for each brewing process and preferably independent of the amount of beverage substrate. This has led to a further vertical displacement of the rod 15 with respect to the locking bush 18, so that the locking bush 18 now engages around the rod 15 or at least sections thereof in the upper section 17 of the rod 15, the upper section 17 having a correspondingly larger cross section. As will be explained in more detail with reference to FIG. 4, an interlocking of the locking bush 18 with respect to the rod 15 can be achieved in the upper section 17 of the rod 15 in any position and thus correspondingly continuously and thus also a continuous interlocking of the brewing unit 12 in a second lower position, which is only caused by the actuating unit 13. It is particularly preferable that the brewing unit 12, in particular the contact surface 36, can be secured in such a manner by an elastic pre-tensioning device, which is not shown in detail in FIGS. 1 to 3, that essentially only an elastic deformation of the pre-tensioning device takes place once the contact surface 36 has been contacted with the beverage substrate 22, and otherwise no or only a minimal movement of the contact surface 36 relative to the beverage substrate holder 03 takes place and otherwise a contact pressure force which is as constant as possible or essentially constant is exerted on the beverage substrate 22 via the elastic pre-tensioning device.

A sensor device, also not shown in detail, can be used to determine the position of the contact surface 36 when the actuation lever 14 reaches the end position and communicate this to a control unit, also not shown, in order to control or influence the operating parameters of the beverage preparation device 01 based on this communication, particularly for a subsequent brewing process.

FIG. 4 shows an enlarged view of the interaction of the rod 15 and the locking bush 18. The locking bush 18 is designed and aligned in such a manner both with regard to the shape of an inner opening and with regard to the alignment and any pre-tensioning or application of force that the rod 15 can enter the locking bush 18 during the transition from the first, lower section 16 to the second, upper section 17. However, as soon as a force is generated vertically upwards by the contact surface 36, for example by pressing on the beverage substrate 22 or an internal pressure in the brewing space or the brewing chamber, the force which is directed upwards results in there being a holding force of the rod 15 on or in the locking bush 18, unless it is overcompensated by a greater force directed vertically downwards, the holding force thus causing the brewing unit 12 to interlock continuously purely mechanically and within the actuating unit 13. The corresponding forces are shown in FIG. 4 using arrows. The locking bush 18 interacts with a holder 23, which aligns the locking bush 18 and via which the interlocking of the locking bush 18 can be released again.

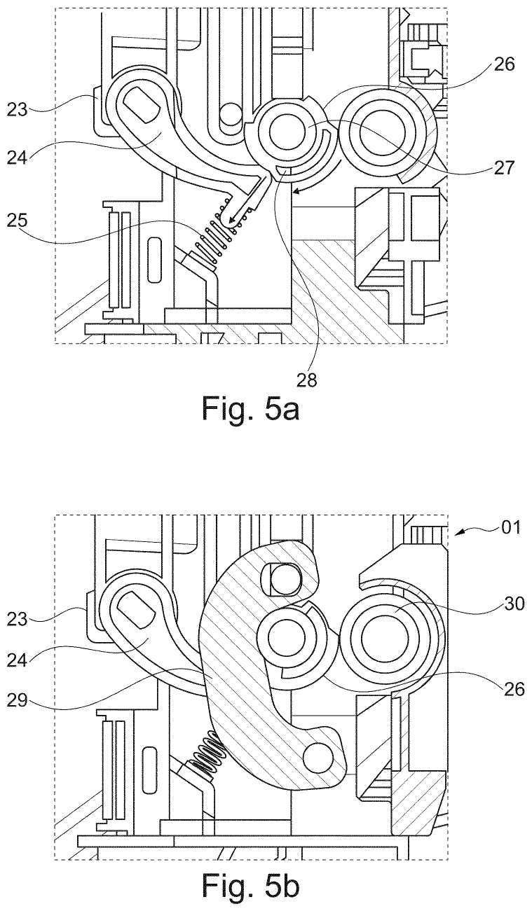

FIG. 5a shows a part of said holder 23, which is designed to interact with a clamping lever 24. The clamping lever 24 is subjected to a force via a spring 25 against a selector slot 26, which is guided on a rotatable shaft 27, the selector slot 26 being limited in its movement by an internal cam 28. FIG. 5a shows the interlocking position of the locking bush 18 as well as the holder 23 and the clamping lever 24. Rotation of the selector slot 26 around the shaft 27 causes the clamping lever 24 to pivot against the pre-tension of the spring 25, which in turn causes the holder 23 to rotate/pivot together with the clamping lever 24. This leads to a tilting of the locking bush 18, which in turn releases the interlocking of the rod 15 in the top section 17 by increasing the effective cross section of the inner opening of the locking bush and releasing the clamping on the rod 15. The selector slot 26 can interact with the operating or actuating lever 14 and the actuating unit 13 in such a manner that when the actuation lever 14 is lifted from the lower end position, the slot 26 actuates the clamping lever 24 and releases or loosens the locking bush 18 via the holder 23.

In a plane which disposed above the drawing plane of FIG. 5a, a toggle lever mechanism can also be provided, which is outlined in FIG. 5b. The toggle lever 29 can also be designed to interact with the actuating unit 13 in such a manner that the toggle lever movement is caused and/or controlled by the operating or adjusting lever 14. In the illustration of FIG. 5b, the toggle lever 29 serves as an additional safety mechanism for interlocking the brewing unit 12 via the purely mechanical, continuous fixing of the rod 15 relative to the locking bush 18 by preventing movement of the slot 26 and thus release of the locking bush 18 via the clamping lever 24 and the holder 23 in the position shown beyond the dead center of the toggle lever 29. When the interlocking of the brewing unit 12 is released, which is initiated by an upward movement of the operating or adjusting lever 14, the mechanism can be designed in such a manner that the dead center of the toggle lever 29 is first overcome, thereby releasing the slot 26, and the slot 26 can move the clamping lever 24 against the spring 25 by rotating about the cam 28.

The toggle lever mechanism together with the toggle lever 29 thus serves as a second locking mechanism to additionally secure the continuous interlocking of the brewing unit 12.

The movement of the slot 26 around the shaft 27 as well as the movement of the toggle lever 29 can preferably be effected by corresponding power transmissions, ratios and/or reductions which originate from a central drive shaft 30, the central drive shaft 30 being able to be designed to interact directly or indirectly with the operating or actuating lever 14.

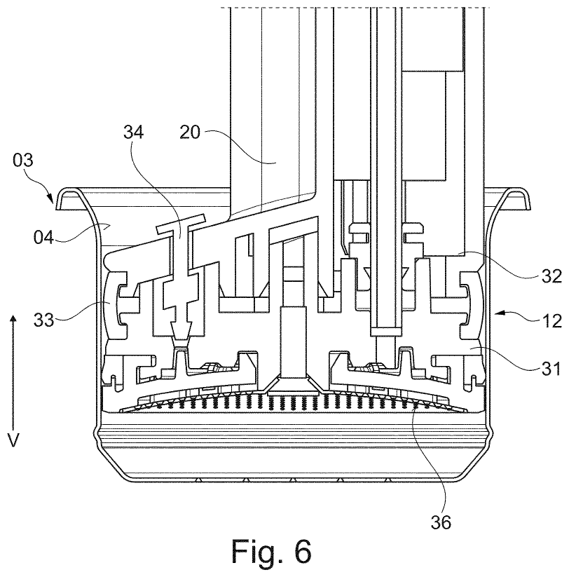

FIG. 6 shows an enlarged view of a brewing unit 12. The brewing unit is located in a beverage substrate holder 03. In particular, the brewing unit 12 is disposed inside a volume delimited by the interior wall 04. The end section of the central guide rod 20 is also shown. The brewing unit 12 comprises a lower part 31 and an upper part 32, which are mounted so as to be movable relative to one another in the vertical direction V and which are connected to one another via the circumferential profile seal 33.

The brewing unit 12 further incorporates a mechanically acuatable valve 34 which, when the upper part 32 and the lower part 31 move relatively towards each other, allows aeration and ventilation of the brewing space or the brewing chamber through the contact surface 36, whereas the mechanically controlled valve 34 closes or changes to a closed state when the upper part 32 moves relatively away from the lower part 31. The profile seal 33 can be provided to pre-tension the upper part 32 and the lower part 31 into a state in which they move away from each other, so that the valve 34 is designed as a normally open valve and only closes when the upper part 32 and the lower part 31 are moved towards each other and at the same time the profile seal 33 bulges outwards radially, which only occurs when a resulting force acts or is applied which causes the upper part and the lower part to move towards each other.

It can be particularly advantageous that when the brewing unit 12 is released from the continuous interlocking via the actuating unit 13, both via the design of the brewing unit 12 according to FIG. 6 and via the realization of the interlocking, as shown for example with reference to FIGS. 5a and 5b, the beverage substrate 22 is first additionally compressed again or a corresponding pressure force is exerted on the beverage substrate 22 before the brewing unit 12 is moved vertically upwards. This makes it possible to achieve additional squeezing of the pomace or the beverage substrate 22 before it is removed from the beverage preparation device 01 by the beverage substrate holder 03.

### Reference Numerals

01 beverage preparation device
02 receptacle
03 beverage substrate holder
04 interior wall
05 sieve
06 discharge element
07 supply shaft
08 1st end
09 2nd end
10 transition
11 mill
12 brewing unit
13 actuating unit
14 actuation lever
15 rod
16 lower section
17 upper section
18 locking bush
19 connection element
20 more guide rod
21 inlet opening
22 beverage substrate
23 holder
24 clamping lever
25 jump
26 selector slot
27 shaft
28 cam
29 toggle lever
30 drive shaft
31 lower part
32 upper part
33 profile seal
34 valve
35 housing part
36 contact surface
V direction

1. A beverage preparation device, in particular a coffee and/or espresso machine, having a beverage substrate holder, in particular a sieve holder, removable from a receptacle, the device having a brewing unit which is displaceable in a vertical direction and is disposed and configured such with respect to the receptacle and the beverage substrate holder received therein that the beverage substrate holder is removable from and insertable in the receptacle in an upper position of the brewing unit and a brewing space formed by the brewing unit and the beverage substrate holder is closed and/or sealed in a first lower position and a vertical contacting against a beverage substrate in the beverage substrate holder takes place in a second lower position, the brewing unit being connected to a brewing water supply in such a manner as to conduct fluid in order to discharge brewing fluid and/or to supply it to the brewing chamber, and the beverage preparation device moreover having a supply duct for providing beverage substrate, the supply duct being disposed and designed such on one end that the beverage substrate can be filled from the supply duct in the beverage substrate holder , which is inserted in the receptacle, merely under the influence of weight and preferably on the other end forms a transition to a mill surrounded by the beverage preparation device, the displaceable brewing unit being configured to interact with a mechanical, in particular manually operable, actuating unit in order to be displaced at least into the upper, first lower and second lower position,
wherein the actuating unit allows a continuous interlocking of the brewing unit in the vertical direction exclusively below a first lower position.

2. The beverage preparation device according to claim 1, wherein the actuating unit has a rod moveable together with the brewing unit and a locking bush which is immobile in the vertical direction and surrounds the rod, the rod being designed such that a fixation in a first lower section via the locking bush is impossible and being designed such in a second upper section that a discontinuation of a vertical downwards movement of the rod results in a locking force fit between the locking bush and the rod, the force fit causing or supporting the interlocking of the brewing unit.

3. The beverage preparation device according to claim 2, further comprising:
a second locking mechanism, preferably a toggle lever mechanism, which is configured such that the interlocking of the brewing unit is achieved and/or supported via the second locking mechanism in addition to the locking bush.

4. The beverage preparation device according to claim 1,
wherein a contact surface of the brewing unit, in particular a wetting or brewing sieve, is movable in the vertical direction against an elastic pre-tensioning device with respect to the actuating unit and/or the remaining part of the brewing unit so that the further movement of the actuating unit and/or the remaining part of the brewing unit results in a reduced movement of the contact surface and in a contact force on the beverage substrate upon a vertical displacement of the brewing unit as soon as the beverage substrate is contacted with the contact surface.

5. The beverage preparation device according to claim 1,
further comprising:
a sensor device for detecting the position of the brewing unit and/or the contact surface in an interlocked position of the brewing unit, the sensor device being designed so as to operatively connect with a control unit of the beverage preparation device so that operating parameters of the beverage preparation device, in particular parameters of a fluid pump for conveying brewing fluid, are indicatable and/or adjustable via the control unit depending on the detected position.

6. The beverage preparation device according to claim 1,
wherein the brewing unit is configured such that a mechanical lock of the beverage substrate holder is achieved upon the displacement of the brewing unit starting with a third lower position.

7. The beverage preparation device according to any one of claim 1,
further comprising:
a contact, preferably as part of a microswitch, by means of which the position of the beverage substrate holder is detected or revisable in the receptacle.

8. The beverage preparation device according to claim 1,
wherein the brewing unit has an upper part and a lower part which are moveably mounted against each other in the vertical direction, a mechanically actuatable valve being designed such in the brewing unit that a relative movement of the upper part and the lower part away from each other opens the valve and allows a ventilation of the brewing unit in particular even below the first lower position of the brewing unit.

9. The beverage preparation device according to claim 8, wherein the upper part and the lower part are connected to each other with a radially circumferential profile seal which causes a radial expansion or swelling of the profile seal upon a relative movement of the upper part and the lower part towards each other, thus achieving a contacting of the profile seal against an inner wall of the beverage substrate holder below the first lower position.
